(19) United States
(12) Patent Application Publication
(10) Pub. No.: US 2026/0237922 A1
(43) Pub. Date: Aug. 13, 2026

(54) ELECTRICAL CONNECTOR WITH IMPROVED TERMINALS

(71) Applicants: FOXCONN (KUNSHAN) COMPUTER CONNECTOR CO., LTD., Kunshan (CN); FOXCON INTERCONNET TECHNOLOGY LIMITED, Grand Cayman (KY)

(72) Inventors: FANG-JWU LIAO, New Taipei (TW); CHI-HSIANG LU, New Taipei (TW); JIA-HAU LIU, New Taipei (TW)

(21) Appl. No.: 19/532,573

(22) Filed: Feb. 6, 2026

(30) Foreign Application Priority Data
Feb. 13, 2025 (CN) 202510160017.1

(51) Int. Cl. H01R 12/55; H01R 13/24; H01R 13/405

(52) U.S. Cl. CPC H01R 12/55; H01R 13/245; H01R 13/405

(57) ABSTRACT

An electrical connector includes: an insulating housing and plural terminal grooves; and plural terminals retained in corresponding terminal grooves; wherein each terminal includes an upper conducting member and a lower conducting member, the upper conducting member includes an upper fixing portion, an upper additional portion, an upper connecting portion connecting the upper fixing portion and the upper additional portion, and an upper elastic arm extending from the upper additional portion with an upper contacting portion, the lower conducting member includes a lower fixing portion, a lower additional portion, a lower connecting portion connecting the lower fixing portion and the lower additional portion, and a lower elastic arm extending from the lower additional portion with a lower contacting portion, and the upper connecting portion and the lower connecting portion are stacked along an upper-lower direction to contact with each other.

### BACKGROUND OF THE INVENTION

### Field of the Invention

The present invention relates to an electrical connector.

### Description of Related Arts

China Patent No. 211126153U discloses an electrical connector having an insulating housing and plural terminals. The insulating housing has plural receiving grooves penetrating an upper face and a lower face thereof. The terminal comprises a first terminal and a second terminal retained in a same receiving groove and are welded together by a first fixing portion of the first terminal and a second fixing portion of the second terminal. The first terminal is inserted into the receiving groove from an upper to lower direction and the second terminal is inserted into the receiving groove from a lower to upper direction. It is hard to assemble the terminals as the first terminal and the second terminal need to be welded together after the first terminal and the second terminal are assembled.

Therefore, it is desired to provide an electrical connector with improved terminals.

### SUMMARY OF THE INVENTION

An object of the present invention is to provide an electrical connector with improved terminals.

To achieve the above object, an electrical connector includes an insulating housing having an upper face, a lower face, and a plurality of terminal grooves penetrating the upper face and the lower face in an upper-lower direction; and a plurality of terminals retained in corresponding terminal grooves; wherein each terminal includes an upper conducting member and a lower conducting member, the upper conducting member includes an upper fixing portion fixed in the terminal groove, an upper additional portion facing to the upper fixing portion, an upper connecting portion connecting the upper fixing portion and the upper additional portion, and an upper elastic arm extending from the upper additional portion with an upper contacting portion above the upper face, the lower conducting member includes a lower fixing portion fixed in the terminal groove, a lower additional portion facing to the lower fixing portion, a lower connecting portion connecting the lower fixing portion and the lower additional portion, and a lower elastic arm extending from the lower additional portion with a lower contacting portion below the lower face, and the upper connecting portion and the lower connecting portion are stacked along the upper-lower direction to contact with each other.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector of this invention;

FIG. 2 is another perspective view of the electrical connector in FIG. 1;

FIG. 3 is an exploded perspective view of the electrical connector in FIG. 1;

FIG. 4 is a perspective view of an upper conducting member and a lower conducting member when an insulating housing is removed in FIG. 1;

FIG. 5 is a front view of the electrical connector in FIG. 1;

FIG. 6 is a side view of the electrical connector in FIG. 1;

FIG. 7 is a cross-sectional view of the electrical connector taken along line A-A of FIG. 1;

FIG. 8 is a perspective view of an electrical connector when the upper elastic arm and the lower elastic arm contact an upper abutting portion and the lower abutting portion respectively in FIG. 1;

FIG. 9 is a perspective view of the upper conducting member and the lower conducting member when the insulating housing is removed in FIG. 8; and

FIG. 10 is a cross-sectional view of the electrical connector taken along line B-B in FIG. 8.

### DETAILED DESCRIPTION OF THE PREFERRED EMBODIMENT

Reference will now be made in detail to the preferred embodiments of the present invention.

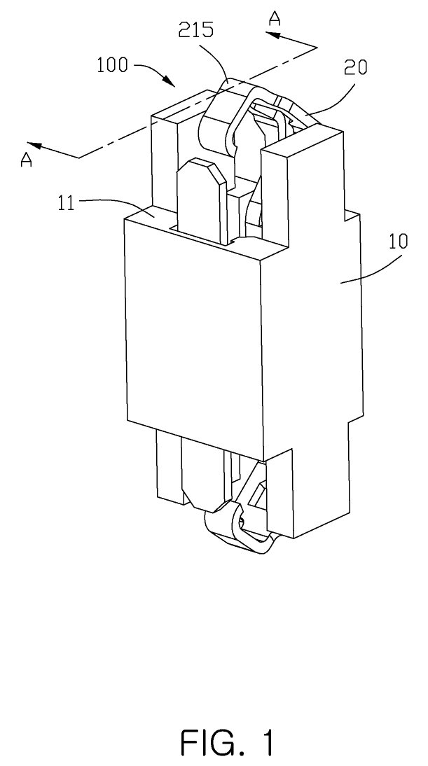

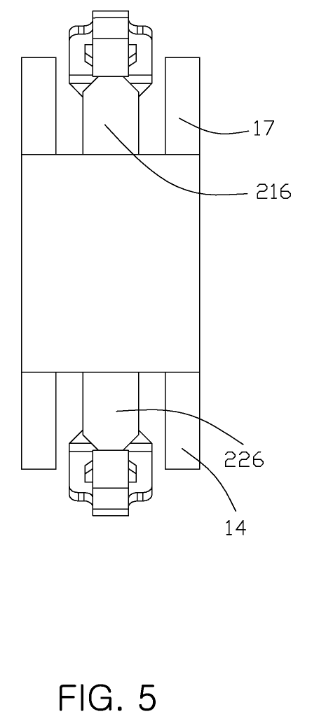

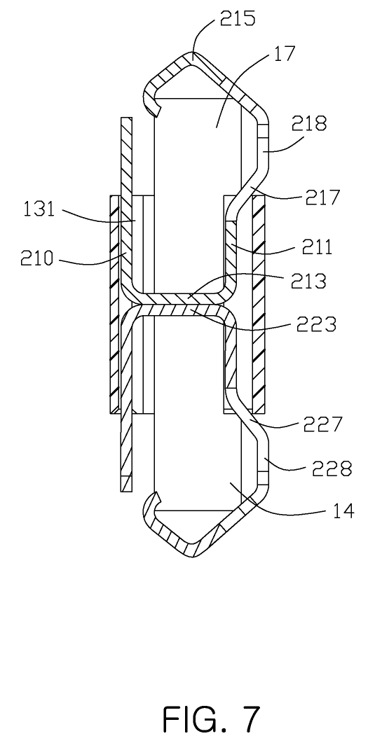

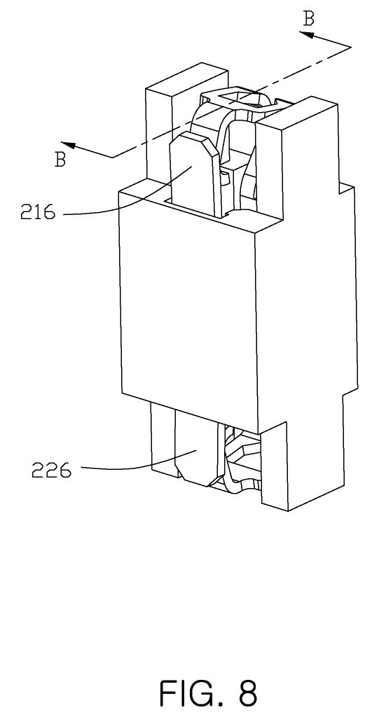

Referring to FIGS. 1-2 and 5-8, an electrical connector 100 is used for electrically connecting an electrical module, e.g., a chip module, to a circuit board or connecting two circuit boards. The electrical connector 100 includes an insulating housing 10 and a plurality of terminals 20 arranged in a matrix. The insulating housing 10 is provided with an upper face 11, a lower face 12, and a plurality of terminal grooves 13 penetrating the upper face 11 and the lower face 12. The terminals 20 are retained in corresponding terminal grooves 13 one by one respectively. It should be noted that, in fact, the electrical connector 100 has hundreds of terminals. In the present invention, only one terminal 20 and one terminal groove 13 are illustrated.

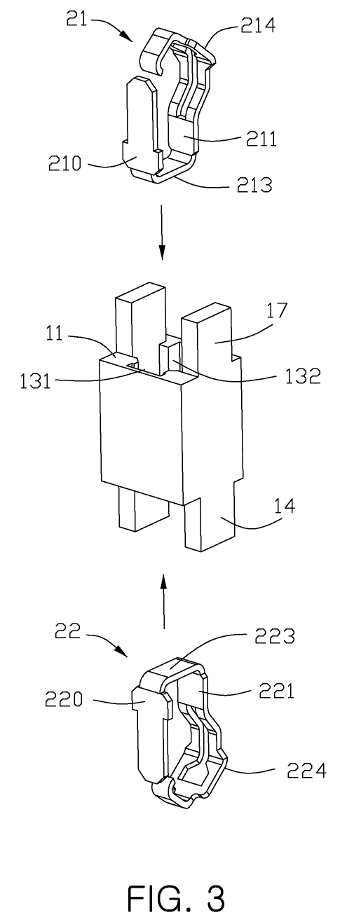

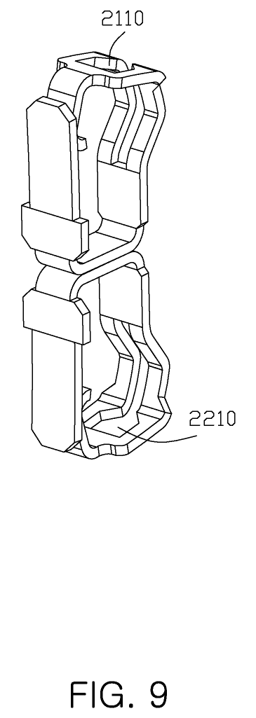

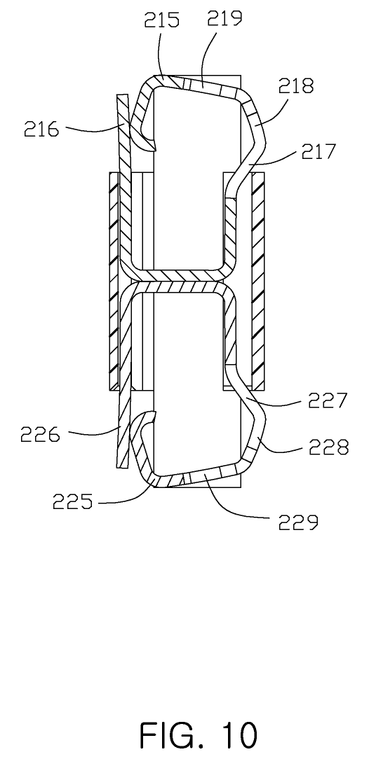

Combined with FIGS. 3-4 and 8-10, each terminal 20 includes a pair of conducting members. One of the conducting members in a pair is at an upper position and is named as an upper conducting member 21, and the other is at a lower position and is named as a lower conducting member 22. Each conducting member has a fixing portion, an additional portion opposite to the fixing portion, a connecting portion therebetween, and an elastic arm extending from the additional portion. The terminal groove 13 includes a fixing slot 131 penetrating the upper face 11 and lower face 12, and a receiving groove 132 intercommunicating with the corresponding fixing slot 131. The fixing portion is fixed within the corresponding fixing slot 131, the connecting portion and the additional portion are received within the receiving groove 132. The elastic arm extends out of the receiving groove 132 and is provided with a contacting portion. The two conducting members of a terminal are inserted into the terminal groove 13 from the upper face 11 and the lower face 12 respectively, that is, the upper conducting member is inserted into the terminal groove 13 along an upper to lower direction and the lower conducting member is inserted into the terminal groove along a lower to upper direction. The two connecting portions of a terminal are stacked and abut against each other along an upper and lower direction. Each conducting member further includes an abutting portion extending vertically from the fixing portion and is exposed outside the corresponding fixing slot 131. The elastic arms contact the corresponding abutting portions when the elastic arms are pressed and retract into the receiving grooves 132.

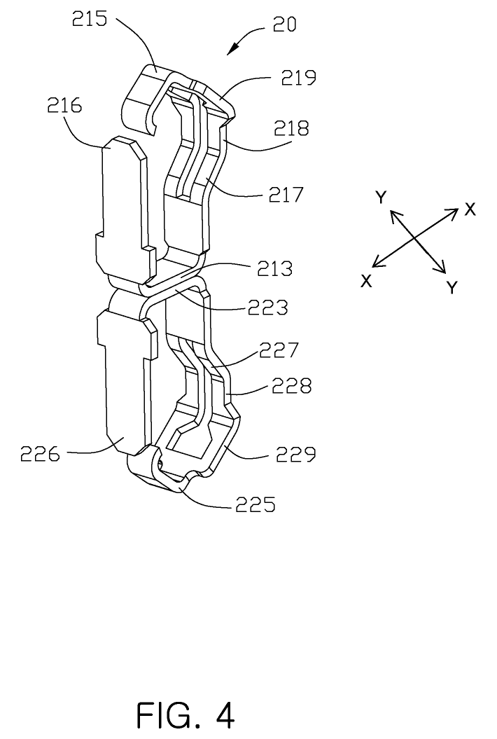

Referring to FIGS. 3-4, preferably, the upper conducting member 21 includes an upper fixing portion 210 fixed in the fixing slot 131, an upper additional portion 211 arranged facing to with the upper fixing portion 210 along a first direction X-X/ front-rear direction, an upper connecting portion 213 extending horizontally and connecting the upper fixing portion 210 and the upper additional portion 211, and an upper elastic arm 214 extending upward from the upper additional portion 211. The upper elastic arm 214 is provided with an upper contacting portion 215 above the upper face 11. The lower conducting member 22 includes a lower fixing portion 220 fixed in the fixing slot 131, a lower additional portion 221 facing to the lower fixing portion 220 along the first direction X-X, a lower connecting portion 223 connecting the upper ends of the lower fixing portion 220 and the lower additional portion 221, and a lower elastic arm 224 extending downward from the lower additional portion 221. The lower elastic arm 224 is provided with a lower contacting portion 225 below the lower face 12. When the upper conducting member 21 and the lower conducting member 22 are properly installed into the terminal groove, the upper connecting portion 213 and the lower connecting portion 223 are stacked and abut against with each other along the upper and lower direction.

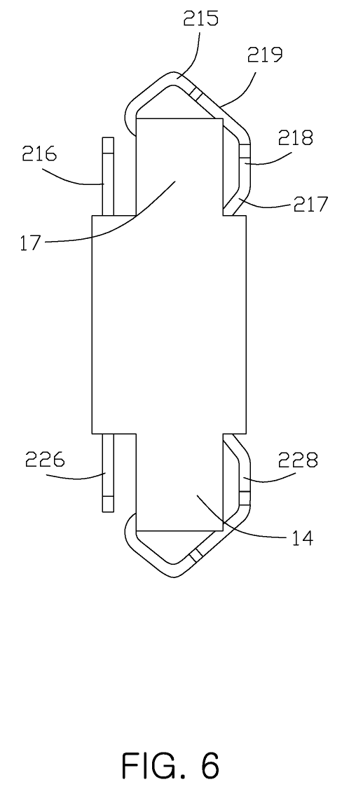

Referring to FIGS. 6-10, the upper conducting member 21 further includes an upper abutting portion 216 extending upward from the upper fixing portion 210. The upper elastic arm 214 contacts the upper abutting portion 216 when it is pressed. Similarly, the lower conducting member 22 includes a lower abutting portion 226 extending downward from the lower fixing portion 220. The lower elastic arm 224 contacts the lower abutting portion 226 when it is pressed. Preferably, in the embodiment, the upper abutting portion 216 extends upward and are exposed over the upper face 11 of insulating housing 10, and the lower abutting portion 226 extends downward and are exposed blow lower face 12 of the insulating housing 10. Preferably, the end of the upper contacting portion 215 bends inward and form an arc-shaped upper touching portion, and the end of the lower contacting portion 225 bend inward and form an arc-shaped lower touching portion. After the upper elastic arm 214 and the lower elastic arm 224 are pressed, the upper abutting portion 216 contacts the upper abutting portion, and the lower abutting portion 226 contacts the lower abutting portion.

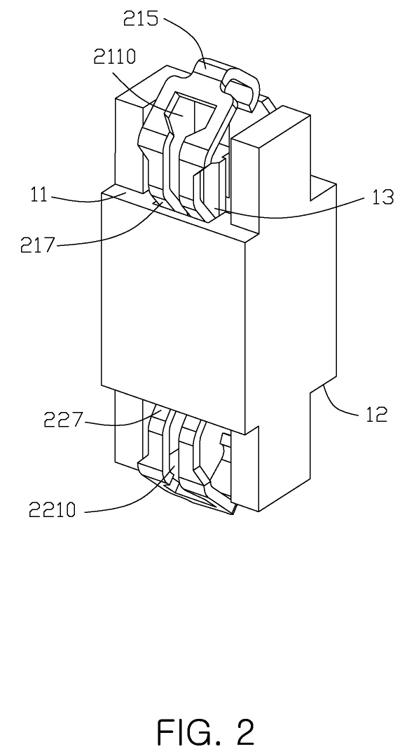

Referring to FIGS. 2-4 and 6-7, in order to ensure the elasticity of the upper elastic arm 214 and the lower elastic arm 224, the upper elastic arm 214 sequentially includes an oblique portion 217 extending upward and outward from the upper additional portion 211, a vertical portion 218 extending upward from the oblique portion 217, an inclining portion 219 extending inward and upward from vertical portion 218, and the upper contacting portion 215 bending from the inclining portion 219. Preferably, the upper contacting portion is inverted V-shaped. Similarly, the lower elastic arm 224 sequentially includes an oblique portion 227 that extending downward and outward from the lower additional portion 221, a vertical portion 228 extending downward from the oblique portion 227, an inclining portion 229 extending inward and downward from the vertical portion 228, and the lower contacting portion 225 bending from the inclining portion. Preferably, the lower contacting portion is V-shaped. The upper elastic arm 214 includes a slot 2110 extending from the oblique portion 217 to the inclining portion 219 along a length thereof, and the lower elastic arm 224 includes a slot 2210 extending from the oblique portion 227 to the inclining portion 229 along a length thereof.

Referring to FIGS. 3-4, 7, and 9-10, preferably, in the embodiment, the upper fixing portion 210 and the upper abutting portion 216 are located in a same vertical plane and are parallel to the upper additional portion 211. The upper connecting portion 213 extends horizontally and connects the upper fixing portion 210 and the upper additional portion 211. The lower fixing portion 220 and the lower abutting portion 226 are located in a same vertical plane and are parallel to the lower additional portion 221. The lower connecting portion 223 extends horizontally and connects the lower fixing portion 220 and the lower additional portion 221. The upper conducting member 21 and the lower conducting member 22 are in mirror image symmetry along the upper and lower direction.

Combined with FIGS. 3-6, the insulating housing 10 further includes plural upper stopping walls 17 extending upward from the upper face 11 of the insulating housing 10 and are located at two sides (a left side and a right side) of the corresponding upper elastic arm 214 along a second direction Y-Y/ left-right direction, and plural lower stopping walls 17 extending downward from the lower face 12 of the insulating housing 10 and located at two sides of the lower elastic arm 224. The upper stopping walls 17 extend upward and exceed the vertical portion 218, and the lower retaining wall 14 extend downward and exceed the vertical portion 228.

Referring to FIGS. 2, 7, and 10, in the embodiment, since the oblique portion 217 inclines upward and outward and is exposed outside the terminal groove 13, the oblique portion 217 abuts against an upper edge of the side wall of the terminal groove 13 when the upper conducting member 21 is installed into the terminal groove 13 along an upper to lower direction, and thus, the upper conducting member 21 can be prevent from being excessively installed downward into the terminal groove 13. For a convenient processing, the fixing slot 131 and the receiving grooves 132 can be set as through grooves along the upper and lower direction, and the upper conducting member 21 and the lower conducing member 22 would not be over-installed into the terminal groove 13 by the oblique portions 217, 227 respectively though the terminal grooves 13 are through along the upper and lower direction. Preferably, the upper and lower fixing portion 210, 220, the upper and lower abutting portion 216, 226, and the upper and lower additional portion 211, 221 are vertical and the upper and lower connecting portion 213, 223 are horizontal, and thus, it is convenient to make the terminals. The upper touching portion contacts the upper abutting portion 216 and the lower touching portion contacts the lower abutting portion 226, and the upper connecting portion 213 contacts with the lower connecting portion 223 when the upper elastic arm 214 and the lower elastic arm 224 are pressed. Preferably, the upper touching portion of the upper elastic arm contacts an inner side face of the upper abutting portion 216 adjacent to the upper elastic arm, and the lower touching portion of the lower elastic arm contacts an inner side face of the lower abutting portion 226. Therefore, the terminals 20 have an improved signal transmission performance with multiple contacting points.

Although the present invention has been described with reference to particular embodiments, it is not to be construed as being limited thereto. Various alterations and modifications can be made to the embodiments without in any way departing from the scope or spirit of the present invention as defined in the appended claims.

1. An electrical connector comprising: an insulating housing having an upper face, a lower face, and a plurality of terminal grooves penetrating the upper face and the lower face in an upper-lower direction; and a plurality of terminals retained in corresponding terminal grooves; wherein each terminal comprises an upper conducting member and a lower conducting member, the upper conducting member comprises an upper fixing portion fixed in the terminal groove, an upper additional portion facing to the upper fixing portion, an upper connecting portion connecting the upper fixing portion and the upper additional portion, and an upper elastic arm extending from the upper additional portion with an upper contacting portion above the upper face, the lower conducting member comprises a lower fixing portion fixed in the terminal groove, a lower additional portion facing to the lower fixing portion, a lower connecting portion connecting the lower fixing portion and the lower additional portion, and a lower elastic arm extending from the lower additional portion with a lower contacting portion below the lower face, and the upper connecting portion and the lower connecting portion are stacked along the upper- lower direction to contact with each other.

2. The electrical connector as claimed in claim 1, wherein the upper conducting member comprises an upper abutting portion extending upward from the upper fixing portion and the lower conducting member comprises a lower abutting portion extending downward from the lower fixing portion, and the upper elastic arm contacts with the upper abutting portion and the lower elastic arm contacts with the lower abutting portion when the upper elastic arm and the lower elastic arm are pressed.

3. The electrical connector as claimed in claim 2, wherein the upper abutting portion is exposed outside the upper face and the lower abutting portion is exposed outside the lower face.

4. The electrical connector as claimed in claim 1, wherein the upper elastic arm successively comprises an oblique portion extending upwardly and outwardly from the upper additional portion, an upper vertical portion, an inclining portion extending upwardly and inwardly and the upper contacting portion, and a free end of the upper contacting portion bends inwardly.

5. The electrical connector as claimed in claim 4, wherein the upper elastic arm further comprises an opening slot extending from the oblique portion to the inclining portion along a length thereof, and the oblique portion abuts against an upper edge of a side wall of the corresponding terminal groove.

6. The electrical connector as claimed in claim 4, wherein the insulating housing comprises plural upper stopping walls extending upward from the upper face of the insulating housing, and two upper stopping walls are located at two sides of corresponding upper elastic arm respectively.

7. The electrical connector as claimed in claim 6, wherein the upper stopping walls are taller than the upper vertical portion.

8. The electrical connector as claimed in claim 4, wherein the upper fixing portion and the corresponding upper vertical portion are in a same vertical plane and are parallel to the upper additional portion.

9. The electrical connector as claimed in claim 4, wherein the upper conducting member and the lower conducting member have a same structure.

10. The electrical connector as claimed in claim 1, wherein the upper connecting portion and the lower connecting portion extend horizontally.

11. An electrical connector comprising: an insulating housing having an upper face, a lower face, and a plurality of terminal grooves penetrating the upper face and the lower face in an upper-lower direction; and a plurality of terminals retained in corresponding terminal grooves; wherein each terminal comprises two conducting members and each comprises a fixing portion fixed in the terminal groove, an additional portion facing and parallel to the fixing portion, a connecting portion connecting the fixing portion and the additional portion, and an elastic arm with an oblique portion extending from the additional portion and a contacting portion exposed outside the insulating housing, one of the two conducting members of each terminal is inserted into the terminal groove from an upper to lower direction and the other conducting member is inserted into the terminal groove from a lower to upper direction, one of the oblique portions of the two elastic arms of each terminal abuts against an upper edge of a side wall of the terminal groove and the other oblique portion abuts against a lower edge of the side wall of the terminal groove, and the two connecting portions of the two conducting members of each terminal abut against each other along the upper-lower direction.

12. The electrical connector as claimed in claim 11, wherein the terminal further comprises an abutting portion extending vertically from the fixing portion and is in a same vertical plane with the fixing portion, and the two elastic arms contact with the corresponding abutting portions when the two elastic arms are pressed.

13. The electrical connector as claimed in claim 11, wherein the two conducting members are in mirror image symmetry along the upper-lower direction.

14. The electrical connector as claimed in claim 11, wherein the elastic arm comprises an opening slot extending along a length thereof and between the corresponding additional portion and the contacting portion.

15. An electrical connector comprising: an insulating housing having an upper face, a lower face, and a plurality of terminal grooves, each terminal groove having a receiving groove penetrating the upper face and the lower face in an upper-lower direction and a fixing slot communicating with the receiving groove; and a plurality of terminals retained in corresponding terminal grooves, each terminal comprising two conducting members; wherein each conducting member comprises a fixing portion fixed in the fixing slot, an abutting portion extending upward from the fixing portion, an additional portion facing and parallel to the fixing portion, a connecting portion connecting the fixing portion and the additional portion, and an elastic arm with a contacting portion, the connecting portion and the additional portion are received in the receiving groove, the connecting portions of the two conducting members of each terminal abut against each other in the upper-lower direction, and free ends of the two elastic arms of each terminal contact with corresponding abutting portions when the terminal is pressed.

16. The electrical connector as claimed in claim 15, wherein the connecting portions extend horizontally and the two conducting members of a terminal are in mirror image symmetry along the upper and lower direction.

17. The electrical connector as claimed in claim 15, wherein the free ends of the elastic arms contact inner faces of corresponding abutting portions facing to the elastic arms when the elastic arms are pressed.
